(19) United States
(12) Patent Application Publication
(10) Pub. No.: US 2012/0192108 A1
(43) Pub. Date: Jul. 26, 2012

(54) GESTURE-BASED MENU CONTROLS

(75) Inventor: Michael Kolb, Palo Alto, CA (US)

(73) Assignee: GOOGLE INC., Mountain View, CA (US)

(21) Appl. No.: 13/250,874

(22) Filed: Sep. 30, 2011

Related U.S. Application Data
(60) Provisional application No. 61/436,572, filed on Jan. 26, 2011.
(60) Provisional application No. 61/480,983, filed on Apr. 29, 2011.

(51) Int. Cl. G06F 3/048

(52) U.S. Cl. 715/810

(57) ABSTRACT

In one example, a method includes receiving a first user input comprising a first motion gesture from a first location of the presence-sensitive screen to a second, different location of the presence-sensitive screen, wherein the first location is substantially at a boundary of a presence-sensing region and a non-sensing region of the presence-sensitive screen. The method also includes, responsive to receiving the first user input, displaying a group of graphical menu elements positioned substantially radially outward from the second location. The method further includes receiving a second user input to select at least one graphical menu element based on a second motion gesture provided at a third location of the presence-sensing region. The method also includes, responsive to receiving the second user input, determining an input operation, wherein the input operation executes a operation associated with the selected at least one graphical menu element.

### RELATED APPLICATIONS

This application claims the benefit of U.S. Provisional Application No. 61/436,572, filed Jan. 16, 2011, the entire content of which is incorporated herein in its entirety. This application also claims the benefit of U.S. Provisional Application No. 61/480,983, filed on Apr. 29, 2011, the entire content of which is incorporated herein in its entirety.

### TECHNICAL FIELD

This disclosure relates to electronic devices and, more specifically, to graphical user interfaces of electronic devices.

### BACKGROUND

A user may interact with applications executing on a mobile computing device (e.g., mobile phone, tablet computer, smart phone, or the like). For instance, a user may install, view, or delete an application on a computing device.

In some instances, a user may interact with the mobile device through a graphical user interface. For instance, a user may interact with a graphical user interface using a presence-sensitive display (e.g., touchscreen) of the mobile device.

### SUMMARY

In one example, a method includes receiving, at a presence-sensitive screen of a mobile computing device, a first user input comprising a first motion gesture from a first location of the presence-sensitive screen to a second, different location of the presence-sensitive screen, wherein the first location is substantially at a boundary of a presence-sensing region and a non-sensing region of the presence-sensitive screen, the second location is in the presence-sensing region of the presence-sensitive screen, and the computing device only detects input in the presence-sensing region and substantially at the boundary. The method also includes, responsive to receiving the first user input, displaying, at the presence-sensitive screen, a group of graphical menu elements positioned substantially radially outward from the second location. The group of graphical menu elements are positioned in the presence-sensing region of the presence-sensitive screen. The method further includes receiving a second user input to select at least one graphical menu element of the group of graphical menu elements based on a second motion gesture provided at a third location of the presence-sensing region, wherein the third location is associated with the at least one graphical menu element. The method also includes, responsive to receiving the second user input, determining, by the mobile computing device, an input operation associated with the second user input and performing the determined operation.

In one example, a computer-readable storage medium includes instructions that, when executed, perform operations including receiving, at a presence-sensitive screen of a mobile computing device, a first user input including a first motion gesture from a first location of the presence-sensitive screen to a second, different location of the presence-sensitive screen, wherein the first location is substantially at a boundary of a presence-sensing region and a non-sensing region of the presence-sensitive screen, the second location is in the presence-sensing region of the presence-sensitive screen, and the computing device only detects input in the presence-sensing region and substantially at the boundary. The computer-readable storage medium further includes instructions that, when executed, perform operations including, responsive to receiving the first user input, displaying, at the presence-sensitive screen, a group of graphical menu elements positioned substantially radially outward from the second location. The computer-readable storage medium also includes instructions that, when executed, perform operations including receiving a second user input to select at least one graphical menu element of the group of graphical menu elements based on a second motion gesture provided at a third location of the presence-sensing region, wherein the third location is associated with the at least one graphical menu element. The computer-readable storage medium further includes instructions that, when executed, perform operations including responsive to receiving the second user input, determining, by the mobile computing device, an input operation associated with the second user input and performing the determined operation.

In one example, a computing device includes: one or more processors. The computing device also includes an input device configured to receive a first user input comprising a first motion gesture from a first location of the presence-sensitive screen to a second, different location of the presence-sensitive screen. The computing device further includes means for determining the first location is substantially at a boundary of a presence-sensing region and a non-sensing region of the presence-sensitive screen, the second location is in the presence-sensing region of the presence-sensitive screen, and the computing device only detects input in the presence-sensing region and substantially at the boundary. The computing device further includes a presence-sensitive screen configured to, responsive to receiving the first user input, display, at the presence-sensitive screen, a group of graphical menu elements positioned substantially radially outward from the second location; wherein, the input device is further configured to receive a second user input to select at least one graphical menu element of the group of graphical menu elements based on a second motion gesture provided at a third location of the presence-sensing region, wherein the third location is associated with the at least one graphical menu element. The computing device further includes an input module executable by the one or more processors and configured to, responsive to receiving the second user input, determine an input operation associated with the second user input and performing the determined operation.

The details of one or more examples of this disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example of a computing device that may be configured to execute one or more applications, in accordance with one or more aspects of the present disclosure.

FIG. 2 is a block diagram illustrating further details of one example of computing device shown in FIG. 1, in accordance with one or more aspects of the present disclosure.

FIG. 3 is a flow diagram illustrating an example method that may be performed by a computing device to quickly display and select menu items provided in a presence-sensitive display, in accordance with one or more aspects of the present disclosure.

FIGS. 4A, 4B are block diagrams illustrating examples of computing devices that may be configured to execute one or more applications, in accordance with one or more aspects of the present disclosure.

FIG. 5 is a block diagram illustrating an example of computing device that may be configured to execute one or more applications, in accordance with one or more aspects of the present disclosure.

FIG. 6 is a flow diagram illustrating an example method that may be performed by a computing device to quickly display and select menu items provided in a presence-sensitive display, in accordance with one or more aspects of the present disclosure.

### DETAILED DESCRIPTION

In general, aspects of the present disclosure are directed to techniques for displaying and selecting menu items provided by a presence-sensitive (e.g., touchscreen) display. Smart phones and tablet computers often receive user inputs as gestures performed at or near a presence-sensitive screen. Gestures may be used, for example, to initiate applications or control application behavior. Quickly displaying multiple selectable elements that control application behavior may pose numerous challenges because screen real estate may often be limited on mobile devices such as smart phones and tablet devices.

In one aspect of the present disclosure, a computing device may include an output device, e.g., a presence-sensitive screen, to receive user input. In one example, the output device may include a presence-sensing region that may detect gestures provided by a user. The output device may further include a non-sensing region, e.g., a perimeter area around the presence-sensing region, which may not detect touch gestures. In one example, the perimeter area that includes the non-sensing region may enclose the presence-sensing region. The output device may also display a graphical user interface (GUI) generated by an application. In one example, an application may include a module that displays a pie menu in response to a gesture. The gesture may be a swipe gesture performed at a boundary of the presence-sensing region and non-sensing region of the output device. For example, a user may perform a touch gesture that originates at the boundary of the non-sensing region of the output device and ends in the presence-sensing region of the output device.

In one example, a user may perform a horizontal swipe gesture that originates at the boundary of the presence-sensing and non-sensing regions of the output device and ends in the presence-sending region of the output device. In response to the gesture, the module of the application may generate a pie menu for display to the user. The pie menu may be a semicircle displayed at the edge of the presence-sensitive screen that includes multiple, selectable “pie-slice” elements. In some examples, the menu elements extend radially outward from the edge of the presence sensing region around the input unit, e.g., the user's finger. Each element may correspond to an operation or application that may be executed by a user selection.

In some examples, the user may move his/her finger to select an element and, upon selecting the element, the module may initiate the operation or application associated with the element. In some examples, the pie menu is displayed until the user removes his/her finger from the presence-sensitive screen. The present disclosure may increase available screen real estate by potentially eliminating the need for a separate, selectable icon to initiate the pie menu. Additionally, a swipe gesture performed at the edge of the presence-sensitive screen may reduce undesired selections of other selectable objects displayed by the screen (e.g., hyperlinks displayed in a web browser). The present disclosure may also reduce the number of user inputs required to perform a desired action.

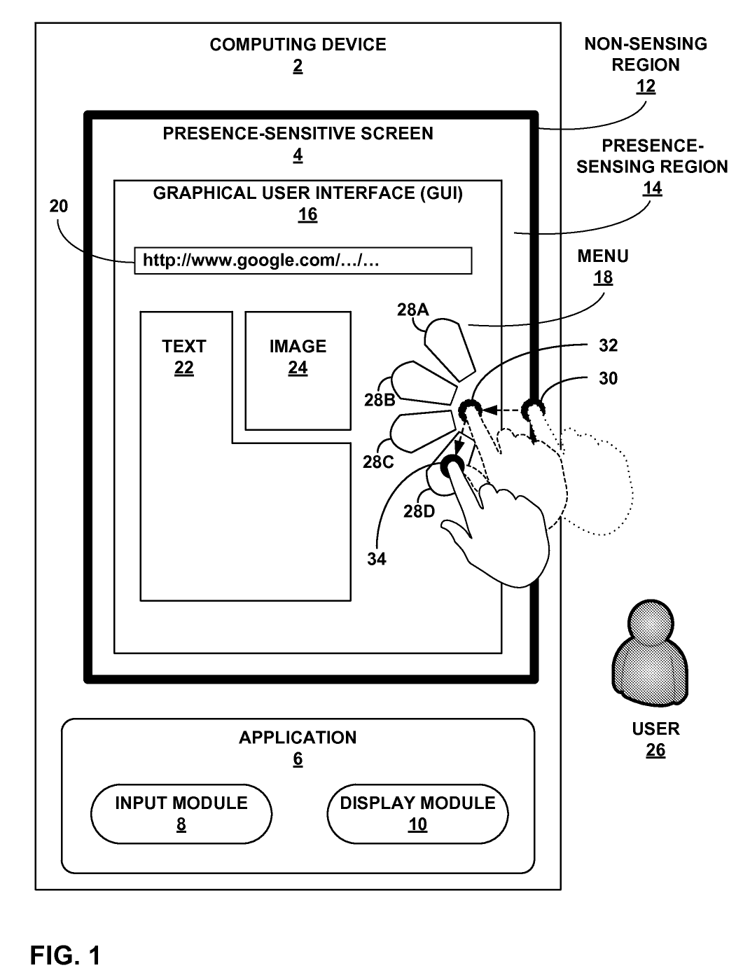

FIG. 1 is a block diagram illustrating an example of a computing device 2 that may be configured to execute one or more applications, e.g., application 6, in accordance with one or more aspects of the present disclosure. As shown in FIG. 1, computing device 2 may include a presence-sensitive screen 4 and an application 6. Application 6 may, in some examples, include an input module 8 and display module 10.

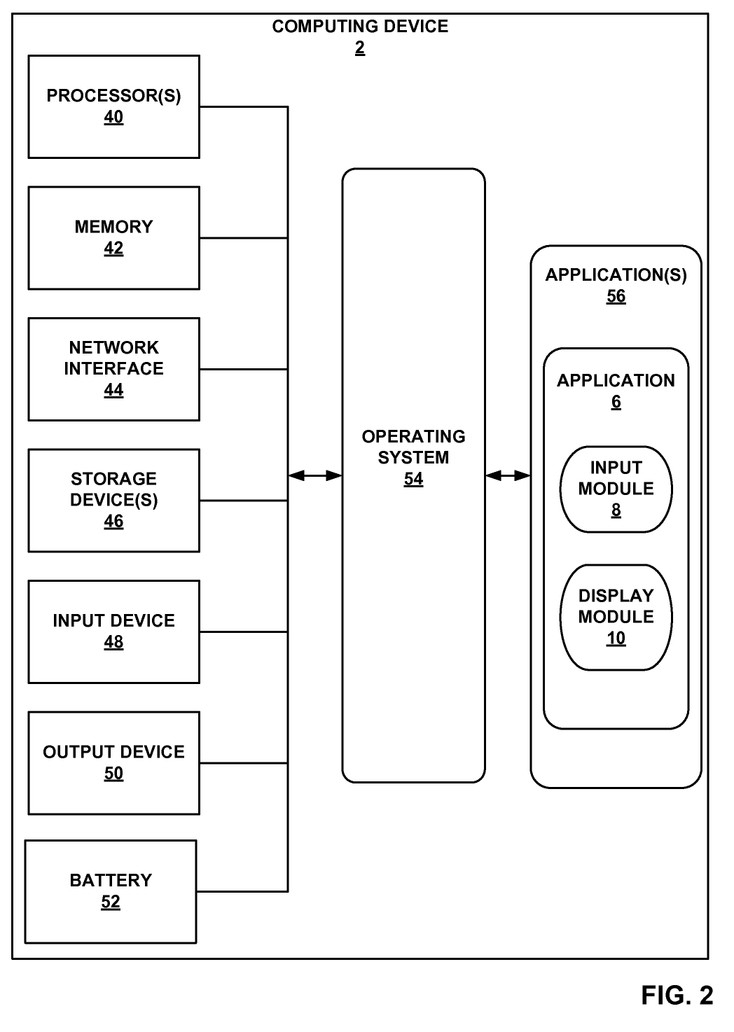

Computing device 2, in some examples, includes or is a part of a portable computing device (e.g. mobile phone/netbook/laptop/tablet device) or a desktop computer. Computing device 2 may also connect to a wired or wireless network using a network interface (see, e.g., network interface 44 of FIG. 2). One non-limiting example of computing device 2 is further described in the example of FIG. 2.

Computing device 2, in some examples, includes one or more input devices. In some examples, an input device may be a presence-sensitive screen 4. Presence-sensitive screen 4, in one example, generates one or more signals corresponding to a location selected by a gesture performed on or near the presence-sensitive screen 4. In some examples, presence-sensitive screen 4 detects a presence of an input unit, e.g., a finger, pen or stylus that may be in close proximity to, but does not physically touch, presence-sensitive screen 4. In other examples, the gesture may be a physical touch of presence-sensitive screen 4 to select the corresponding location, e.g., in the case of a touch-sensitive screen. Presence-sensitive screen 4, in some examples, generates a signal corresponding to the location of the input unit. Signals generated by the selection of the corresponding location are then provided as data to applications and other components of computing device 2.

In some examples, presence-sensitive screen 4 may include a presence-sensing region 14 and non-sensing region 12. Non-sensing region 12 of presence-sensitive screen 4 may include an area of presence-sensitive screen 4 that may not generate one or more signals corresponding to a location selected by a gesture performed at or near presence-sensitive screen 4. In contrast, presence-sensing region 14 may include an area of presence-sensitive screen 4 that generates one or more signals corresponding to a location selected by a gesture performed at or near the presence-sensitive screen 4. In some examples, an interface between presence-sensing region 14 and non-sensing region 12 may be referred to as a boundary of presence-sensing region 14 and non-sensing region 12. Computing device 2, in some examples, may only detect input in presence-sensing region 14 and at the boundary of presence-sensing region 14 and non-sensing region 12. Presence-sensitive screen 4 may, in some examples, detect input substantially at the boundary of the presence-sensing region 14 and non-sensing region 12. Thus, in one example, computing device 2 may determine a gesture performed within, e.g., 0-0.25 inches of the boundary also generates a user input.

In some examples, computing device 2 may include an input device such as a joystick, camera or other device capable of recognizing a gesture of user 26. In one example, a camera capable of transmitting user input information to computing device 2 may visually identify a gesture performed by user 26. Upon visually identifying the gesture of the user, a corresponding user input may be received by computing device 2 from the camera. The aforementioned examples of input devices are provided for illustration purposes and other similar example techniques may also be suitable to detect a gesture and detected properties of a gesture.

In some examples, computing device 2 includes an output device, e.g., presence-sensitive screen 4. In some examples, presence-sensitive screen 4 may be programmed by computing device 2 to display graphical content. Graphical content, generally, includes any visual depiction displayed by presence-sensitive screen 4. Examples of graphical content may include image 24, text 22, videos, visual objects and/or visual program components such as scroll bars, text boxes, buttons, etc. In one example, application 6 may cause presence-sensitive screen 4 to display graphical user interface (GUI) 16.

As shown in FIG. 1, application 6 may execute on computing device 2. Application 6 may include program instructions and/or data that are executable by computing device 2. Examples of application 6 may include a web browser, email application, text messaging application or any other application that receives user input and/or displays graphical content.

In some examples, application 6 causes GUI 16 to be displayed in presence-sensitive screen 4. GUI 16 may include interactive and/or non-interactive graphical content that presents information of computing device 2 in human-readable form. In some examples GUI 16 enables user 26 to interact with application 6 through presence-sensitive screen 4. For example, user 26 may perform a gesture at a location of presence-sensitive screen 4, e.g., typing on a graphical keyboard (not shown) that provides input to input field 20 of GUI 16. In this way, GUI 16 enables user 26 to create, modify, and/or delete data of computing device 2.

As shown in FIG. 1, application 6 may include input module 8 and display module 10. In some examples, display module 10 may display menu 18 upon receiving user input from user 26. For example, user 26 may initially provide a first user input by performing a first motion gesture that originates from a first location 30 of presence-sensitive screen 4. The first motion gesture may be a horizontal swipe gesture such that user 26 moves his/her finger from first location 30 to second location 32. Input module 8 may receive data generated by presence-sensitive screen 4 that indicates the first motion gesture.

In the current example, first location 30 may be at the boundary of presence-sensing region 14 and non-sensing region 12 as shown in FIG. 1. In some examples, input module 8 may detect user 26 has placed his/her finger at first location 30. As user 26 moves his/her finger from first location 30 to second location 32, input module 8 may receive data generated by presence-sensitive screen 4 that indicates the movement of the input unit to second location 32. As shown in FIG. 1, second location 32 may be located in presence-sensing region 14.

As described above, input module 8 may determine a user has performed a gesture at a location substantially at a boundary of a presence-sensing region and a non-sensing region of the presence-sensitive screen 4. For example, presence-sensitive screen 4 may initially generate a signal that represents the selected location of the screen. Presence-sensitive screen 4 may subsequently generate data representing the signal, which may be sent to input module 8. In some examples, the data may represent a set of coordinates corresponding to a coordinate system used by presence-sensitive screen 4 to identify a location selected on the screen. To determine the selected location is at a boundary, input module 8 may compare the location specified in the data with the coordinate system. If the input module 8 determines the selected location is at a boundary of the coordinate system, input module 8 may determine the selected location is at a boundary of the presence-sensing and non-sensing regions of the presence-sensitive screen 4. In some examples, boundaries of the coordinate system may be identified by minimum and maximum values of one or more axes of the coordinate system. As described herein, a gesture performed substantially at a boundary may indicate a location in the coordinate system near a minimum or maximum value of one or more axes of the coordinate system.

In some examples, display module 10 may display menu 18 that includes a group of graphical menu elements 28A-28D in response to receiving data from input module 8. For example, data from input module 8 may indicate that presence-sensitive screen 4 has received a first user input from user 26. Graphical menu elements 28A-28D may be displayed substantially radially outward from second location 32 as shown in FIG. 1. In some examples, menu 18 may be referred to as a pie menu.

Graphical menu elements 28A-28D may, in some examples, be arranged in a substantially semi-circular shape as shown in FIG. 1. Graphical menu elements 28A-28D may in some examples correspond to one or more operations that may be executed by computing device 2. Thus, when a graphical menu element is selected, application 6 may execute one or more corresponding operations. In one example, application 6 may be a web browser application. Each graphical menu element 28A-28D may represent a web browser navigation operation, e.g., Back, Forward, Reload, and Home. In one example, a user may select a graphical menu element corresponding to the Reload navigation operation. In such an example, application 6 may execute the Reload navigation operation, which may reload a web page.

Selecting a menu element is further described herein. As previously described, user 26, in a first motion gesture, may move his/her finger from first location 30 to second location 32, which may display menu 18. To select a graphical menu element, e.g., graphical menu element 28D, user 46 may move his/her finger from second location 32 to a third location 34 of presence-sensitive screen 4. Third location 34 may be included in presence-sensing region 14 of presence-sensitive screen 4. In some examples, third location 34 may correspond to the position of graphical menu element 28D as displayed in GUI 16 by presence-sensitive screen 4.

To select graphical menu element 28D, user 26 may perform a second motion gesture at third location 28D of presence-sensing region 15 associated with graphical menu element 28D. Responsive to the second motion gesture, application 6 may receive a second user input corresponding to the second motion gesture. In one example, the second motion gesture may include user 26 removing his/her finger from presence-sensing region 14. In such an example, input module 8 may determine that the finger of user 26 is no longer detectable once the finger is removed from proximity of presence-sensitive screen 4. In other examples, user 26 may perform a long press gesture at third location 28D. User 26 may, in one example perform a long press gesture by placing his/her finger at third location 28D for approximately 1 second or more while the finger is in proximity to presence-sensitive screen 4. An input unit in proximity to presence sensitive screen 4 may indicate the input unit is detectable by presence-sensitive screen 4. In other examples, the second motion gesture may be, e.g., a double-tap gesture. User 26 may perform a double-tap gesture, in one example, by successively tapping twice at or near third location 28D. Successive tapping may include tapping twice in approximately 0.25-1.5 seconds.

In some examples, input module 8 may, responsive to receiving the second user input, determine an input operation that executes an operation associated with the selected graphical menu element. For example, as shown in FIG. 1, user 26 may select graphical menu element 28D. Graphical menu element 28D may correspond to a Reload navigation operation when application 6 is a web browser application. Application 6 may determine, based on the second user input associated with selecting element 28D, an input operation that executes the Reload navigation operation. A user's selection of a graphical menu element may initiate any number of operations. For example, an input operation may include launching a new application, generating another pie menu, or executing additional operations within the currently executing application.

In some examples, application 6 may remove graphical menu elements 28A-28D from display in presence-sensitive screen 4 when an input unit is no longer detectable by presence-sensing region 14. For example, an input unit may be a finger of user 26. Application 6 may remove graphical menu elements 28A-28D when user 26 removes his/her finger from presence-sensitive screen 4. In this way, application 6 may quickly display and remove from display graphical menu elements 28A-28D. Moreover, additional gestures to remove graphical menu elements from display are not required because user 26 may conveniently remove his/her finger from presence-sensitive screen 4.

Various aspects of the disclosure may therefore, in certain instances, increase the available area for display in an output device while providing access to graphical menu elements. For example, aspects of the present disclosure may provide a technique to display graphical menu elements without necessarily displaying a visual indicator that may be used to initiate display of graphical menu elements. Visual indicators and/or icons may consume valuable display area of an output device that may otherwise be used to display content desired by a user. As described herein, initiating display of graphical menu elements responsive to a gesture originating at a boundary of a presence-sensing region and non-sensing region of an output device potentially eliminates the need to display a visual indicator used to initiate display of the one or more graphical menu elements because a user may, in some examples, readily identify a boundary of a non-sensing and presence-sensing region of an output device.

Various aspects of the disclosure, may in some examples improve a user experience of a computing device. For example, an application may cause an output device to display content such as text, images, hyperlinks, etc. In one example, such content may be included in a web page. In some examples, a gesture performed at a location of an output device that displays content may cause the application to perform an operation associated with selecting the object. As the amount of selectable content displayed by the output device increases, the remaining screen area available to receive a gesture for initiating display of graphical menu elements may decrease. Thus, when a large amount of selectable content is displayed, a user may inadvertently select, e.g., a hyperlink, when the user has intended to perform a gesture that initiates a display of menu elements.

Aspects of the present disclosure may, in one or more instances, overcome such limitations by identifying a gesture originating from a boundary of a presence-sensing region and non-sensing region of an output device. In some examples, selectable content may not be displayed near the boundary of the presence-sensing region and non-sensing region of an output device. Thus, a gesture performed by a user at the boundary may be less likely to inadvertently select an unintended selectable content. In some examples, positioning the pie menu substantially at the boundary may quickly display a menu in a user-friendly manner while reducing interference with the underlying graphical content that is displayed by the output device. Moreover, a user may readily identify the boundary of the presence-sensing and non-sensing regions of an output device, thereby potentially enabling the user to more quickly and accurately initiate display graphical menu elements.

FIG. 2 is a block diagram illustrating further details of one example of computing device 2 shown in FIG. 1, in accordance with one or more aspects of the present disclosure. FIG. 2 illustrates only one particular example of computing device 2, and many other example embodiments of computing device 2 may be used in other instances.

As shown in the specific example of FIG. 2, computing device 2 includes one or more processors 40, memory 42, a network interface 44, one or more storage devices 46, input device 48, output device 50, and battery 52. Computing device 2 also includes an operating system 54. Computing device 2, in one example, further includes application 8 and one or more other applications 56. Application 8 and one or more other applications 56 are also executable by computing device 2. Each of components 40, 42, 44, 46, 48, 50, 52, 54, 56, and 6 may be interconnected (physically, communicatively, and/or operatively) for inter-component communications.

Processors 40, in one example, are configured to implement functionality and/or process instructions for execution within computing device 2. For example, processors 40 may be capable of processing instructions stored in memory 42 or instructions stored on storage devices 46.

Memory 42, in one example, is configured to store information within computing device 2 during operation. Memory 42, in some examples, is described as a computer-readable storage medium. In some examples, memory 42 is a temporary memory, meaning that a primary purpose of memory 42 is not long-term storage. Memory 42, in some examples, is described as a volatile memory, meaning that memory 42 does not maintain stored contents when the computer is turned off. Examples of volatile memories include random access memories (RAM), dynamic random access memories (DRAM), static random access memories (SRAM), and other forms of volatile memories known in the art. In some examples, memory 42 is used to store program instructions for execution by processors 40. Memory 42, in one example, is used by software or applications running on computing device 2 (e.g., application 6 and/or one or more other applications 56) to temporarily store information during program execution.

Storage devices 46, in some examples, also include one or more computer-readable storage media. Storage devices 46 may be configured to store larger amounts of information than memory 42. Storage devices 46 may further be configured for long-term storage of information. In some examples, storage devices 46 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 2, in some examples, also includes a network interface 44. Computing device 2, in one example, utilizes network interface 44 to communicate with external devices via one or more networks, such as one or more wireless networks. Network interface 44 may be a network interface card, such as an Ethernet card, an optical transceiver, a radio frequency transceiver, or any other type of device that can send and receive information. Other examples of such network interfaces may include Bluetooth®, 3G and WiFi® radios in mobile computing devices as well as USB. In some examples, computing device 2 utilizes network interface 44 to wirelessly communicate with an external device (not shown) such as a server, mobile phone, or other networked computing device.

Computing device 2, in one example, also includes one or more input devices 48. Input device 48, in some examples, is configured to receive input from a user through tactile, audio, or video feedback. Examples of input device 48 include a presence-sensitive screen (e.g., presence-sensitive screen 4 shown in FIG. 1), a mouse, a keyboard, a voice responsive system, video camera, microphone or any other type of device for detecting a command from a user. In some examples, a presence-sensitive screen includes a touch-sensitive screen.

One or more output devices 50 may also be included in computing device 2. Output device 50, in some examples, is configured to provide output to a user using tactile, audio, or video stimuli. Output device 50, in one example, includes a presence-sensitive screen (e.g., presence-sensitive screen 4 shown in FIG. 1), sound card, a video graphics adapter card, or any other type of device for converting a signal into an appropriate form understandable to humans or machines. Additional examples of output device 50 include a speaker, a cathode ray tube (CRT) monitor, a liquid crystal display (LCD), or any other type of device that can generate intelligible output to a user.

Computing device 2, in some examples, may include one or more batteries 52, which may be rechargeable and provide power to computing device 2. Battery 52, in some examples, is made from nickel-cadmium, lithium-ion, or other suitable material.

Computing device 2 may include operating system 54. Operating system 54, in some examples, controls the operation of components of computing device 2. For example, operating system 54, in one example, facilitates the interaction of application 6 with processors 40, memory 42, network interface 44, storage device 46, input device 48, output device 50, and battery 52. As shown in FIG. 2, application 6 may include input module 8 and display module 10 as described in FIG. 1. Input module 8 and display module 10 may each include program instructions and/or data that are executable by computing device 2. For example, input module 8 may includes instructions that cause application 6 executing on computing device 2 to perform one or more of the operations and actions described in FIGS. 1-4. Similarly, display module 10 may include instructions that cause application 6 executing on computing device 2 to perform one or more of the operations and actions described in FIGS. 1-4.

In some examples, input module 8 and/or display module 10 may be a part of operating system 54 executing on computing device 2. In some examples, input module 8 may receive input from one or more input devices 48 of computing device 2. Input module 8 may for example recognize gesture input and provide gesture data to, e.g., application 6.

Any applications, e.g., application 6 or other applications 56, implemented within or executed by computing device 2 may be implemented or contained within, operable by, executed by, and/or be operatively/communicatively coupled to components of computing device 2, e.g., processors 40, memory 42, network interface 44, storage devices 46, input device 48, and/or output device 50.

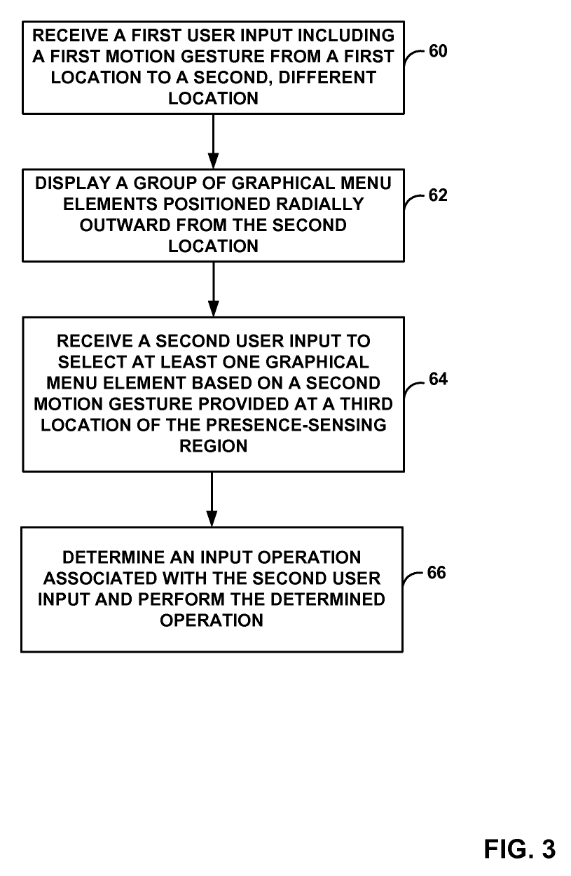

FIG. 3 is a flow diagram illustrating an example method that may be performed by a computing device to display and select menu items provided in a presence-sensitive display, in accordance with one or more aspects of the present disclosure. For example, the method illustrated in FIG. 3 may be performed by computing device 2 shown in FIGS. 1 and/or 2.

The method of FIG. 3 includes, receiving, at a presence-sensitive screen of a mobile computing device, a first user input comprising a first motion gesture from a first location of the presence-sensitive screen to a second, different location of the presence-sensitive screen, wherein the first location is substantially at a boundary of a presence-sensing region and a non-sensing region of the presence-sensitive screen, the second location is in the presence-sensing region of the presence-sensitive screen, and the computing device only detects input in the presence-sensing region and substantially at the boundary (60). The method further includes displaying, at the presence-sensitive screen, a group of graphical menu elements positioned substantially radially outward from the second location, responsive to receiving the first user input, wherein the group of graphical menu elements are positioned in the presence-sensing region of the presence-sensitive screen (62).

The method further includes, receiving a second user input to select at least one graphical menu element of the group of graphical menu elements based on a second motion gesture provided at a third location of the presence-sensing region, wherein the third location is associated with the at least one graphical menu element (64). The method further includes, responsive to receiving the second user input, determining, by the mobile computing device, an input operation associated with the second user input and performing the determined operation (66).

In some examples, the first motion gesture from the first location of the presence-sensitive screen to the second location includes a motion of at least one input unit at or near the presence-sensing region of the presence-sensitive screen. In some examples, the method includes removing from display, the group of graphical menu elements when the input unit is removed from the presence-sensitive screen and no longer detectable by the presence-sensing region of the presence-sensitive screen. In some examples, the motion gesture includes a swipe gesture, wherein the first location and the second location are substantially parallel, and wherein the motion of the at least one input unit generates a substantially parallel path from the first location to the second location.

In some examples, the substantially parallel path includes a horizontal or a vertical path. In some examples, the one or more graphical menu elements are associated with one or more operations of a web browser application. In some examples, the second motion gesture includes a motion of at least one input unit at or near the presence-sensing region of the presence-sensitive screen. In some examples, the second motion gesture includes a long-press or a double-tap gesture.

In some examples, one or more of the group of graphical menu elements includes a wedge or sector shape. In some examples, displaying the group of graphical menu elements is not initiated responsive to selecting one or more icons displayed by the presence-sensitive screen. In some examples, no graphical menu elements of the group of graphical menu elements are displayed prior to receiving the first user input. In some examples, the boundary of the presence-sensing region and the non-sensing region of the presence-sensitive screen includes a perimeter area, wherein the perimeter area includes an area that encloses the presence-sensing region. In some examples, the presence-sensitive screen comprises a touch- or presence-sensitive screen. In some examples, the group of menu elements is arranged in a substantially semi-circular shape.

In some examples the method may include displaying, at the presence-sensitive screen and concentrically adjacent to the group of graphical menu elements, a second of graphical menu elements positioned substantially radially outward from the second location. In some examples a first distance between a first graphical menu element of the group of graphical menu elements and the second location may be less than a second distance between a second graphical menu element of the second group of graphical menu elements and the second location. In some examples, the group of graphical menu elements and the second group of graphical menu elements may each be displayed responsive to the first user input.

In some examples, the mehod may include selecting, by the computing device, a statistic that indicates a number of occurrences that a first operation and a second operation are selected by a user. The method may further include determining, by the computing device, that the first operation is selected more frequently than the second operation based on the statistic. The method may also include, responsive to determining the first operation is selected more frequently than the second operation, associating, by the computing device, the first operation with the first graphical menu element and associating the second operation with the second graphical menu element.

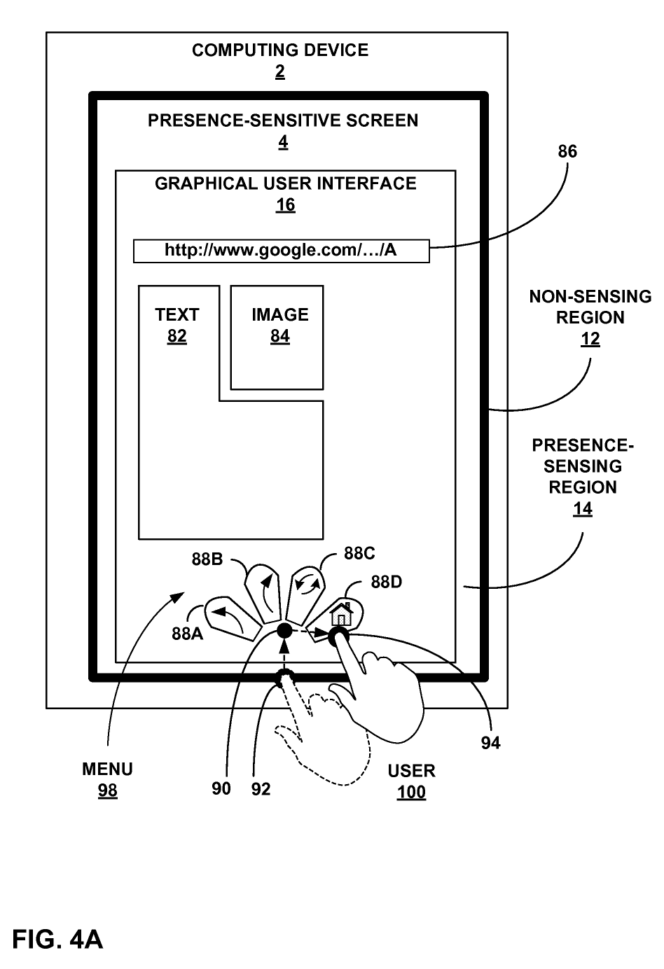

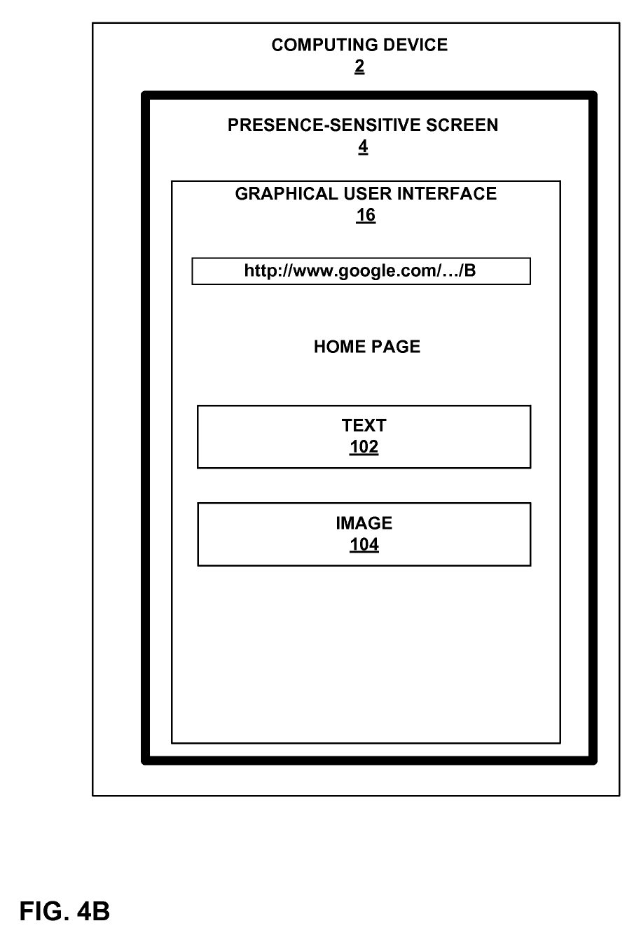

FIGS. 4A, 4B are block diagrams illustrating examples of computing device 2 that may be configured to execute one or more applications, e.g., application 6 as shown in FIG. 1, in accordance with one or more aspects of the present disclosure. As shown in FIGS. 4A and 4B, computing device 2 and the various components included in FIG. 4A, 4B may include similar properties and characteristics as described in FIGS. 1 and 2 unless otherwise described hereinafter. As shown in FIG. 4A, computing device 2 may include presence-sensitive screen 4 and GUI 16. GUI 16 may further include input field 86, text 82, and image 84. Computing device 2 may further include a web browser application, similar to application 6 as shown in FIG. 1, which includes an input module and display module.

In one example use case, computing device 2 of FIG. 4A may execute a web browser application. The web browser application may display content of Hypertext Markup Language (HTML) documents in human-interpretable form. In the current example, an HTML document may include text 82 and image 84, which may be displayed by presence-sensitive screen 4 in GUI 16. In some examples, an HTML document may further include hyperlinks (not shown) that, when selected by a user 100, cause the web browser to access a resource specified by a URL associated with the hyperlink. The web browser may further include input field 86. In the current example, input field 86 may be an address bar that enables user 100 to enter a Uniform Resource Locator (URL). A URL may specify a location of a resource, such as an HTML document. In the current example, user 100 may enter a URL of an HTML document for display.

A web browser in some examples, may include multiple operations to change the web browser's behavior. For example, a web browser may include operations to navigate to previous or subsequent web pages that have been loaded by the web browser. In one example, user 100 may load web pages A, B, and C in sequence. User 100 may use a Backward operation to navigate from web page C to web page B. In another example, user 100 may navigate from web page B to web page C using a Forward operation. Thus, the Backward operation causes the web browser to navigate to a web page prior to the current web page, while the Forward operation causes the web browser to navigate to the web page subsequent to the current web page.

A web browser may, in some examples, include a Homepage operation. The Homepage operation may enable user 100 to specify a URL that identifies a web page as a homepage. A homepage may be a web page frequently accessed by user 100. A web browser may, in some examples, include a Reload operation. A reload operation may cause the web browser to re-request and/or reload the current web page.

In the current example, a web browser application executing on computing device 2 may implement one or more aspects of the present disclosure. For example, the web browser application may display menu 98, which may include graphical menu elements 88A-88D in response to a gesture. In the current example, graphical menu elements 88A-88D may correspond, respectively, to Backward, Forward, Reload, and Homepage operations as described above.

In the current example, user 100 may wish to navigate from a current web page as shown in FIG. 4A to a homepage as displayed in FIG. 4B. Initially, no graphical menu elements may be displayed prior to receiving a user input. User 100 may perform a vertical swipe gesture from first location 92 to second location 90 of presence-sensitive screen 4, as shown in FIG. 4A. First location 92 may be at a boundary of presence-sensing region 14 and non-sensing region 12. In the example of FIG. 4A, first location 92 and second location 90 may be positioned substantially parallel in presence-sensitive screen 4. A vertical swipe gesture performed by user 100 may include moving an input unit along a substantially parallel path from first location 92 to second location 90. In another example, a horizontal swipe gesture may include moving an input unit along a substantially parallel path from a first location a second location that is substantially, horizontally parallel.

The web browser application executing on computing device 2 may, responsive to receiving a first user input that corresponds to the vertical swipe gesture, display graphical menu elements 88A-88D of menu 98 in a semi-circular shape as shown in FIG. 4A. User 100, in the current example, may provide a second motion gesture at a third location 94 of presence sensitive screen 4. Third location 94 may correspond to graphical menu element 88D that may be associated with a Homepage operation. In one example, the second motion gesture may include user 100 releasing his/her finger from third location 88D such that his/her finger is no longer detectable by presence sensitive screen 4.

Responsive to receiving a second user input that corresponds to the second motion gesture, the web browser application may execute the Homepage operation. The Homepage operation may cause the web browser to navigate to a homepage specified by user 100. In some examples, the web browser application may remove menu 98 from display once user 100 has provided the second motion gesture to select a graphical menu element. For example, as shown in FIG. 4B, computing device 2 may display a homepage in GUI 16 with menu 98 removed from display after user 100 has removed his/her finger from presence-sensitive screen 4 of FIG. 4A. The homepage may include text 102 and image 104. In this way, user 100 may use menu 98 to navigate efficiently between multiple web pages using aspects of the present disclosure.

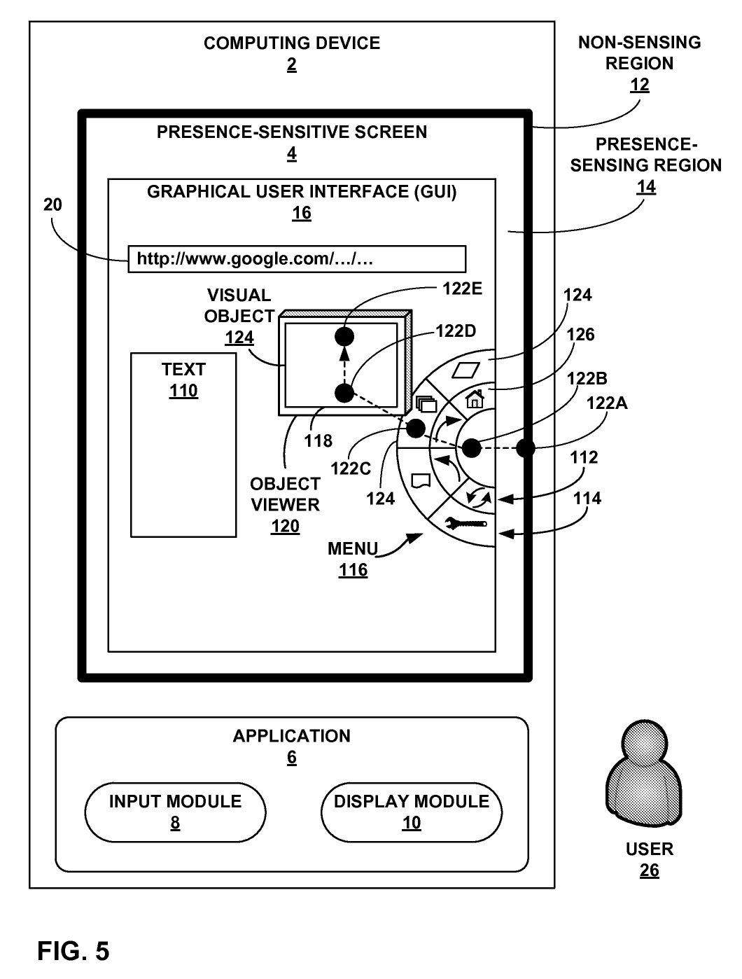

FIG. 5 is a block diagram illustrating an example of computing device 2 that may be configured to execute one or more applications, e.g., application 6, in accordance with one or more aspects of the present disclosure. As shown in FIG. 5, computing device 2 and the various components included in FIG. 5 may include similar properties and characteristics as described in FIGS. 1 and 2 unless otherwise described hereinafter. As shown in FIG. 5, computing device 2 may include presence-sensitive screen 4 and GUI 16. GUI 16 may further include input field 20, text 110, menu 116, and object viewer 120. Menu 116 may further include graphical menu elements, e.g., elements 124 and 126. Graphical menu elements may be positioned into first group of graphical elements 112 and second group of graphical elements 114. Object viewer 120 may further include visual object 124. Computing device 2 may further include a web browser application, similar to application 6 as shown in FIG. 1, which includes an input module and display module.

As shown in FIG. 5, application 6 may display menu 116 responsive to receiving a first user input as described in FIGS. 1 and 2. For example, user 26 may perform a touch gesture comprising a motion from first location 122A to second location 122B. As shown in FIG. 5, first location 122A may be at a boundary of presence-sensing region 14 and non-sensing region 12. Second location 122B may be a different location than first location 122A and may further be located in presence-sensing region 14.

In some examples, menu 116 may display one or more groups of graphical menu elements. For example as shown in FIG. 5, menu 116 may include first group of graphical menu elements 112 and second group of graphical menu elements 114. Application 6 may associate one or more operations with one or more graphical menu elements. In some examples, application 6 may position a group of graphical menu elements substantially radially outward from, e.g., second location 122B. As shown in FIG. 5, application 6 may display first group of graphical menu elements 112 concentrically adjacent to second group of graphical menu elements 114. In some examples, each group of graphical menu elements may be displayed approximately simultaneously when user 26 provides a first user input including a gesture from first location 122A to second location 122B. Thus, each group of graphical menu elements may be displayed responsive to a user input. In this way, application 6 may display each group of graphical menu elements to user 26 with a single gesture.

As shown in FIG. 5, a first distance may exist between graphical menu element 126 of first group 112 and second location 112B. A second distance may exist between graphical menu element 124 of second group 114 and second location 112B. In some examples, the first distance may be less than the second distance such that graphical menu elements of first group 112 may be in close proximity to second location 112B than graphical menu elements of second group 114.

In other examples, application 6 may initially display first group 112 responsive to a first user input. When user 26 selects a graphical menu element of first group 112, application 6 may subsequently display second group 114. In one example, graphical menu elements of second group 114 may be based on the selected graphical menu element of first group 112. For example, a graphical menu element of first group 112 may correspond to configuration settings for application 6. Responsive to a user selecting the configuration setting graphical menu element, application 6 may display a second group that includes graphical menu elements associated with operations to modify configuration settings.

As described throughout this disclosure, a graphical menu element may be associated with a operation executable by computing device 2. For example, a graphical menu element may be associated with a Homepage operation. When a user selects the graphical menu element, application 6 may cause computing device 2 to execute the Homepage operation. Application 6, in some examples, may determine how frequently each operation associated with a graphical menu element is selected by a user. For example, application 6 may determine and store statistics that include a number of occurrences that each operation associated with a graphical menu element is selected by a user.

Application 6 may use one or more statistics to associate more frequently selected operations with graphical menu elements that are displayed in closer proximity to a position of an input unit, e.g., second location 122B. For example, as shown in FIG. 5, user 26 may move his or her finger from first location 122A to second location 122B in order to display menu 116.

To generate menu 116 for display, application 6 may select one or more statistics that indicate the number of occurrences that each operation has been selected. More frequently selected operations may be associated with graphical menu elements in first group 112, which may be closer to the input unit of user 26 at second location 122B than second group 114. Less frequently selected operations may be associated with graphical menu elements in second group 114, which may be farther from second location 122B than first group 112. Because the input unit used by user 26 may be located at second location 122B when application 6 displays menu 116, user 26 may move the input unit a shorter distance to graphical menu elements associated with more frequently occurring operations. In this way, application 6 may use statistics that indicate frequencies with which operations are selected to reduce the distance and time an input unit requires to select a operation. Although a statistic as described in the aforementioned example included a number of occurrences, application 6 may use a probability, average, or other suitable statistic to determine a frequency with which a operation may be selected. Application 6 may use any such suitable statistic to reduce the distance traveled of an input unit and the time required by a user to select a graphical menu element.

In some examples, application 6 may cause presence-sensitive screen 4 to display an object viewer 120. For example, user 26 may initially provide a first user input that includes a motion from first location 122A to second location 122B. Responsive to receiving the first user input, application 6 may display menu 116. User 26 may select an element of menu 116, e.g., element 124, by providing a second user input that includes a motion from second location 122B to third location 122C. As shown in FIG. 5, third location 122C may correspond to a location of presence-sensitive screen 4 that displays element 124. Application 6 may determine a user input, e.g., a finger, is detected by presence sensitive screen 4 at third location 122C and consequently application 6 may cause presence-sensitive screen 4 to display object viewer 120.

Object viewer 120 may display one or more visual objects. Visual objects may include still (picture) and/or moving (video) images. In one example, a group of visual objects may include images that represent one or more documents displayable by presence-sensitive screen 4. For example, GUI 16 may be a graphical user interface of a web browser. GUI 16 may therefore display HTML documents that include, e.g., text 110. Each HTML document opened by application 6 but not currently displayed by presence-sensitive screen 4 may be represented as visual object in object viewer 120.

Application 6 may enable a user 26 to open, view, and manage multiple HTML documents using object viewer 120. For example, at a point in time, GUI 16 may display a first HTML document while multiple other HTML document may also be open but not displayed by presence-sensitive screen 4. Using object viewer 124, user 26 may view and select different HTML documents. For example visual object 124 may be a thumbnail image that represents an HTML document opened by application 6 but not presently displayed by presence-sensitive screen 4.

In the current example, to select a different HTML document, user 26 may move his or her finger to a fourth location 122D. Fourth location 122D may be a location of presence-sensitive screen 4 that displays object viewer 120. At this point, user 26 may wish to change the HTML document displayed by presence-sensitive screen 4. To do so, user 26 may provide a third user input that includes a motion of his or her finger from fourth location 122D to fifth location 122E. Fifth location 122E may also be a location of presence-sensitive screen 4 that displays object viewer 120. Fifth location 122E may also correspond to another location different from fourth location 122D. As shown in FIG. 5, the gesture may be a substantially vertical swipe gesture. A vertical swipe gesture may include moving an input unit from one location to another different location while the input unit is detectable by presence-sensitive screen 4.

Responsive to receiving the third user input that includes a gesture from fourth location 122D to fifth location 122E, application 6 may change the visual object included in object viewer 12. For example, a different visual object than visual object 124 may be provided to object viewer 120 together with visual object 124. In other examples, a different visual object may replace visual object 124, e.g., user 26 may scroll through multiple different visual objects. In the example of multiple thumbnail images that represent HTML documents, user 26 may scroll through the thumbnail images of the object viewer to identify a desired HTML document. Once the user has identified the desired HTML document, e.g., the thumbnail image is displayed by presence-sensitive screen 4 in object viewer 120, user 26 may provide a user input that includes releasing his or her finger from presence-sensitive screen 4 to select the desired HTML document. Application 6, responsive to determining user 26 has selected the thumbnail image may perform an associated operation. For example, an operation performed by application 6 may cause presence-sensitive screen 4 to display the selected HTML document associated with the thumbnail image. In this way, user 26 may use object viewer 120 to quickly change the HTML document displayed by presence-sensitive screen 4 using menu 116.

Although object viewer 120 is described in an example of user 26 switching between multiple HTML documents, aspects of the present disclosure including object viewer 120 and visual object 124 are not limited to a web browser application and/or switching between HTML documents, and may be applicable in any of a variety of examples.

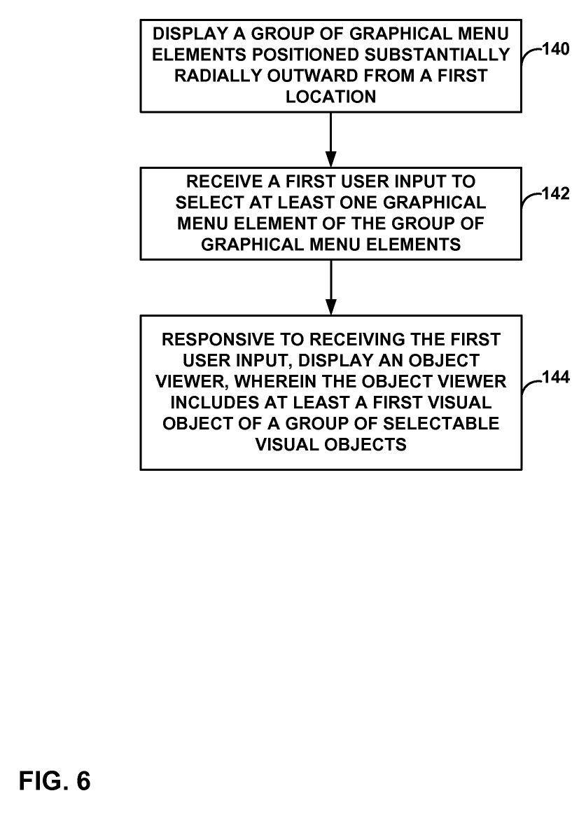

FIG. 6 is a flow diagram illustrating an example method that may be performed by a computing device to quickly display and select menu items provided in a presence-sensitive display, in accordance with one or more aspects of the present disclosure. For example, the method illustrated in FIG. 6 may be performed by computing device 2 shown in FIGS. 1, 2 and/or 5.

The method of FIG. 6 includes, displaying, at a presence-sensitive screen, a group of graphical menu elements positioned substantially radially outward from a first location (140). The method also includes receiving a first user input to select at least one graphical menu element of the group of graphical menu elements (142). The method further includes, responsive to receiving the first user input, displaying, by the presence-sensitive screen, an object viewer, wherein the object viewer includes at least a first visual object of a group of selectable visual objects (144).

In some examples, the group of selectable visual objects may include a group of images representing one or more documents displayable by the presence-sensitive screen. In some examples, the group of selectable visual object may include one or more still or moving images. In some examples, the method includes receiving, at the presence-sensitive screen of the computing device, a second user input that may include a first motion gesture from a first location of the object viewer to a second, different location of the object viewer. The method may also include, responsive to receiving the second user input, displaying, at the presence-sensitive screen, at least a second visual object of the group of selectable visual objects that is different from the at least first visual object.

In some examples, the method includes receiving a third user input to select the at least second visual object. The method may further include, responsive to selecting the at least second visual object, determining, by the computing device, an operation associated with the second visual object. In some examples, the operation associated with the second visual object may further include selecting, by the computing device, a document for display in the presence-sensitive screen, wherein the document is associated with the second visual object. In some examples, the first motion gesture may include a vertical swipe gesture from the first location of the object viewer to the second, different location of the object viewer. In some examples, displaying at least the second visual object of the group of selectable visual objects that is different from the at least first visual object further includes scrolling through the group of selectable visual objects.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects of the disclosure have been described. These and other embodiments are within the scope of the following claims.

1. A method comprising:
receiving, at a presence-sensitive screen of a mobile computing device, a first user input comprising a first motion gesture from a first location of the presence-sensitive screen to a second, different location of the presence-sensitive screen, wherein the first motion gesture comprises a first motion of at least one input unit at or near a presence-sensing region of the presence-sensitive screen, wherein:
the first location is substantially at a boundary of the presence-sensing region and a non-sensing region of the presence-sensitive screen,
the second location is in the presence-sensing region of the presence-sensitive screen, and
the mobile computing device only detects input received at the presence-sensing region and substantially at the boundary;
responsive to receiving the first user input, displaying, at the presence-sensitive screen, a group of graphical menu elements positioned substantially radially outward from the second location, wherein the group of graphical menu elements are positioned within the presence-sensing region of the presence-sensitive screen;
in response to removal of the at least one input unit from the presence-sensitive screen such that the at least one input unit is no longer detectable at the presence-sensing region of the presence-sensitive screen, removing from display, by the mobile computing device, the group of graphical menu elements;
receiving a second user input at the presence-sensitive screen to select at least one graphical menu element of the group of graphical menu elements, wherein the second user input comprises a second motion gesture provided at a third location of the presence-sensing region, wherein the third location is associated with the at least one graphical menu element;
responsive to receiving the second user input, determining, by the mobile computing device, an input operation associated with the second user input and
performing, by the mobile computing device, the determined input operation.

2-3. (canceled)

4. The method of claim 1, wherein:
the first motion gesture comprises a swipe gesture,
the first location and the second location are substantially parallel, and
the first motion of the at least one input unit comprises a substantially parallel path from the first location to the second location.

5. The method of claim 4, wherein the substantially parallel path comprises a horizontal or a vertical path.

6. The method of claim 1, wherein the group of graphical menu elements are associated with one or more operations of a web browser application.

7. The method of claim 1, wherein the second motion gesture comprises a second motion of the at least one input unit at or near the presence-sensing region of the presence-sensitive screen.

8. The method of claim 7, wherein the second motion gesture comprises a long-press or a double-tap gesture.

9. The method of claim 1, wherein one or more of the group of graphical menu elements comprises a wedge or sector shape.

10. The method of claim 1, wherein displaying the group of graphical menu elements is not initiated responsive to a selection of one or more icons displayed by the presence-sensitive screen.

11. The method of claim 1, wherein no graphical menu elements of the group of graphical menu elements are displayed prior to receiving the first user input.

12. The method of claim 1, wherein the boundary of the presence-sensing region and the non-sensing region of the presence-sensitive screen comprises a perimeter area, wherein the perimeter area comprises an area that encloses the presence-sensing region.

13. The method of claim 1, wherein the presence-sensitive screen comprises a touch-sensitive screen.

14. The method of claim 1, wherein the group of menu elements is arranged in a substantially semi-circular shape.

15. The method of claim 1, further comprising:
displaying, at the presence-sensitive screen and concentrically adjacent to the group of graphical menu elements, a second group of graphical menu elements positioned substantially radially outward from the second location,
wherein a first distance between a first graphical menu element of the group of graphical menu elements and the second location is less than a second distance between a second graphical menu element of the second group of graphical menu elements and the second location.

16. The method of claim 15, wherein the group of graphical menu elements and the second group of graphical menu elements are each displayed responsive to the first user input.

17. The method of claim 15, further comprising:
selecting, by the computing device, a statistic that indicates a number of occurrences that a first operation and a second operation are selected by a user;
determining, by the computing device, that the first operation is selected more frequently than the second operation based on the statistic; and
responsive to determining the first operation is selected more frequently than the second operation, associating, by the computing device, the first operation with the first graphical menu element and associating the second operation with the second graphical menu element.

18. A computer-readable storage medium comprising instructions that, when executed by a processor, perform operations comprising:
receiving, at a presence-sensitive screen of a mobile computing device, a first user input comprising a first motion gesture from a first location of the presence-sensitive screen to a second, different location of the presence-sensitive screen, wherein the first motion gesture comprises a first motion of at least one input unit at or near a presence-sensing region of the presence-sensitive screen, wherein:
the first location is substantially at a boundary of the presence-sensing region and a non-sensing region of the presence-sensitive screen,
the second location is in the presence-sensing region of the presence-sensitive screen, and
the mobile computing device only detects input received at the presence-sensing region and substantially at the boundary;
responsive to receiving the first user input, displaying, at the presence-sensitive screen, a group of graphical menu elements positioned substantially radially outward from the second location, wherein the group of graphical menu elements are positioned within the presence-sensing region of the presence-sensitive screen;
in response to removal of the at least one input unit from the presence-sensitive screen such that the at least one input unit is no longer detectable at the presence-sensing region of the presence-sensitive screen, removing from display, by the mobile computing device, the group of graphical menu elements;
receiving a second user input at the presence-sensitive screen to select at least one graphical menu element of the group of graphical menu elements, wherein the second user input comprises a second motion gesture provided at a third location of the presence-sensing region, wherein the third location is associated with the at least one graphical menu element;
responsive to receiving the second user input, determining, by the mobile computing device, an input operation associated with the second user input and
performing, by the mobile computing device, the determined input operation.

19. A computing device, comprising:
one or more processors;
an input device configured to receive a first user input comprising a first motion gesture from a first location of the presence-sensitive screen to a second, different location of the presence-sensitive screen, wherein the first motion gesture comprises a first motion of at least one input unit at or near a presence-sensing region of the presence-sensitive screen;
an input module executable by the one or more processors and configured to determine the first location is substantially at a boundary of the presence-sensing region and a non-sensing region of the presence-sensitive screen, the second location is in the presence-sensing region of the presence-sensitive screen, and the mobile computing device only detects input received at the presence-sensing region and substantially at the boundary;
a presence-sensitive screen configured to, responsive to receiving the first user input, display, at the presence-sensitive screen, a group of graphical menu elements positioned substantially radially outward from the second location, wherein the group of graphical menu elements is positioned within the presence-sensing region of the presence-sensitive screen,
wherein in response to removal of the at least one input unit from the presence-sensitive screen such that the at least one input unit is no longer detectable at the presence-sensing region of the presence-sensitive screen, the input module is configured to remove from display, by the mobile computing device, the group of graphical menu elements; and
wherein, the input device is further configured to receive a second user input at the presence-sensitive screen to select at least one graphical menu element of the group of graphical menu elements, wherein the second user input comprises a second motion gesture provided at a third location of the presence-sensing region, wherein the third location is associated with the at least one graphical menu element;
in response to a second user input being received at the presence-sensitive screen, the input module is configured to determine an input operation associated with the second user input; and
wherein the input module is configured to perform the determined input operation.

20. The computing device of claim 19, wherein the first motion gesture from the first location of the presence-sensitive screen to the second location comprises a first motion of at least one input unit at or near the presence-sensing region of the presence-sensitive screen.
